(19) United States
(12) Patent Application Publication
(10) Pub. No.: US 2015/0095940 A1
(43) Pub. Date: Apr. 2, 2015

(54) PLAYLIST CONTENT SELECTION SYSTEM AND METHOD

(71) Applicant: THOMSON LICENSING, Issy de Moulineaux (FR)

(72) Inventor: William Gibbens Redmann, Glendale, CA (US)

(73) Assignee: THOMSON LICENSING

(21) Appl. No.: 14/395,577

(22) PCT Filed: Dec. 12, 2012
(86) PCT No.: PCT/US2012/068868

§ 371 Date: Oct. 20, 2014

Related U.S. Application Data
(60) Provisional application No. 61/661,453, filed on Jun. 19, 2012.

(51) Int. Cl. H04N 21/262; H04N 21/414; H04N 21/258; H04N 21/488

(52) U.S. Cl. CPC H04N 21/26258; H04N 21/4882; H04N 21/41415; H04N 21/25825
USPC 725/32

(57) ABSTRACT

Selection of an ancillary content title for inclusion in a content play list with a digital cinema feature occurs by first determining the format attributes (e.g., aspect ratio, image stereoscopy, frame rate and peak bit rate) associated with the digital feature. In response to operator identification of a desired digital ancillary content title, a determination is made to determine if that ancillary content title has format attributes at least compatible with the format of the digital feature. If so, the ancillary content title is added to the play list. Otherwise, the operator receives a warning, which depending on the compatibility determination can be overridden.

### CROSS-REFERENCE TO RELATED APPLICATIONS

This application claims priority under 35 U.S.C. 119(e) to U.S. Provisional Patent Application Ser. No. 61/661,453, filed Jun. 19, 2012, the teachings of which are incorporated herein.

### TECHNICAL FIELD

This invention relates to digital cinema presentations.

### BACKGROUND ART

Historically, digital cinema exhibition systems have allowed exhibitors (e.g., movie theater personnel, such as the projectionist) to select content included in a playlist associated with a digital cinema presentation. For purposes of discussion, a digital cinema presentation comprises at least one and typically several pieces of content. Each piece of content represents a particular title in having a particular set of format attributes, with each title typically available in one or more sets of format attributes as described hereinafter. Some titles constitute features (e.g., digital cinema features), whereas other titles constitute ancillary content. Ancillary content titles includes advertisements, trailers, and other non-feature content (e.g., teasers, ratings notices, shorts, transitionals, public service announcements, and policy statements), as listed in Table 2 of the Society of Motion Picture and Television Engineers (SMPTE) Standard 429-7,

At the designated show time(s), a computer server, comprising part of the digital cinema exhibition system, will play out the content on the playlist to the digital cinema projector for display to the audience. A projectionist or other movie theater personnel would set the digital cinema projector and house automation equipment to the set of corresponding format attributes of the content listed on the playlist. For example, the projectionist will set the masking for the aspect ratio to one of “scope” or “flat” and will set the projector format likewise prior to display of the content. With the addition of many new formats (especially 4K, high frame rate, and 3 dimensional (3D) high frame rate), making the necessary adjustments has become much more complex and prior manual methods challenge even the most experienced projectionists.

Some digital cinema servers now include a setting to generate a 3D output stream, even if an individual content title did not have a 3D format. For 2D content, the digital cinema server, when set in this manner, will generate an output stream as if it were the left and right eye images of a 2D composition, with the result that the projector would not have to change modes between 2D and 3D content. Usually, a projectionist will manually set the digital cinema server for application to the whole playlist. However, even though exhibitors (as a matter of policy) tend to show ancillary content titles that share the same aspect ratio as the digital cinema feature(s), no provision exists for separating ancillary content titles by aspect ratio, or for generating a warning upon the selection of a differently formatted ancillary content titles for inclusion in a playlist. Further, there no mechanism currently exists for automatically adjusting a non-optimal selection by the projectionist, when a better choice exists.

### BRIEF SUMMARY OF THE INVENTION

Briefly, a method for selecting a digital ancillary content title for presentation with a digital cinema feature commences by first determining a set of format attributes for the digital cinema feature. Next, an ancillary content title is selected so its set of format attributes is compatible with the format attributes of the digital cinema feature. If no the ancillary content title has a compatible set of format attributes, then a warning is generated.

### BRIEF DESCRIPTION OF THE DRAWINGS

FIG. 1 depicts an exemplary matrix showing playback conditions for ancillary content titles having different sets of format attributes on a digital cinema projector set for different sets of format attributes for testing whether the digital cinema feature and the ancillary content title have compatible aspect ratios;

FIG. 2 depicts an exemplary matrix showing playback conditions for ancillary content titles having different sets of format attributes on a digital cinema projector set for different sets of format attributes for testing whether the digital cinema feature and ancillary content title have compatible resolutions;

FIG. 3 depicts an exemplary matrix showing playback conditions for ancillary content titles having different sets of format attributes on a digital cinema projector set for different sets of format attributes for testing whether the ancillary content title and the digital cinema feature have like or different dimensionality (i.e., two-dimensional vs. three-dimensional);

FIG. 4 depicts an exemplary matrix showing playback conditions for ancillary content titles having different sets of format attributes on a digital cinema projector set for different sets of format attributes for testing whether the ancillary content title and the digital cinema feature have compatible frame rates (e.g., 24 fps, 48 fps);

FIG. 5 depicts an exemplary matrix showing playback conditions for ancillary content titles having different sets of format attributes on a digital cinema projector set for different sets of format attributes for testing whether the ancillary content title and the digital cinema feature have compatible peak bit rates (e.g., 250 Mb/s, 450 Mb/s);

FIG. 6 depicts an exemplary matrix showing playback conditions for ancillary content titles having different sets of format attributes on a digital cinema projector set for different sets of format attributes for testing whether ancillary content title has a compatible set of format attributes for the digital cinema feature in accordance with the individual tests depicted in the matrices of FIGS. 1-5;

FIG. 7 depicts a block schematic diagram of a digital cinema exhibition system for implementing the format attribute compatibility testing technique of the present principles;

FIG. 8 depicts, in flow chart form, the steps of a method in accordance with a first embodiment of the present principles for execution on the digital cinema exhibition system of FIG. 7 for creating a content play list;

FIG. 9 depicts, in flow chart form, the steps of a method in accordance with a second embodiment of the present principles for execution on the digital cinema exhibition system of FIG. 7 for creating a content play list; and

FIG. 10 depicts a content playlist created in accordance with the present principles.

### DETAILED DESCRIPTION

Presently, a digital cinema feature, such as movie in digital form, can have different format attributes. For example, a digital cinema feature can exist in either 2D or 3D. The digital cinema feature can have different resolutions (e.g., 2K or 4K), different aspect ratios (e.g., “flat” or “scope”), different frame rates (e.g., 24 fps or 48 fps) and/or different bandwidths (peak bit rates) (e.g., 250 Mb/s or 450 Mb/s) as described in greater detail hereinafter. Present day digital cinema exhibition systems typically support at least one and typically several different sets of format attributes. (Each set of format attributes corresponds to a particular resolution, aspect ratio, frame rate and peak bit rate as described hereinafter.) As discussed previously, a digital cinema presentation typically comprises one or more digital cinema features and one or more ancillary content titles, including trailers and/or advertisements. Each digital cinema presentation has a set of format attributes corresponding to one of a set of format attributes sets supported by the digital cinema exhibition system so the presentation can as play out satisfactorily. A digital cinema presentation composition whose set of format attributes are unsupported by the digital cinema exhibition system will not undergo play out, either because the digital cinema exhibition system cannot physically undertake the play out, or the play out, if possible, will appear unsatisfactory to the viewing audience. For example, a digital cinema presentation having a 3D format cannot undergo play out by a digital cinema projector that does not support 3D, or a digital cinema exhibition system that does not have a 3D-compatible screen.

In practice, a digital cinema projector placed in a particular configuration compatible with the set of format attributes associated with a digital cinema feature will remain in that configuration throughout a playlist that includes the feature(s) and associated ancillary content title(s). Some ancillary content titles will have a set of format attributes fully compatible with the digital cinema projector configuration while other ancillary content titles may not be supported, or supported only with some degree of degradation. Whether those ancillary content titles having a degraded set of format attributes can undergo play out depends on the exhibitor's policy. Likewise, whether and when a digital cinema projector will undertake a transition to accommodate a different set of format attributes as compared to those associated with the digital cinema feature also remains a matter of exhibitor policy.

The improved playlist selection technique of the present principles serves to codify format attribute compatibilities and policies for use by a digital cinema exhibition system in selecting ancillary content title(s) to accompany one or more digital cinema features in a playlist. Further, the same information can find application in choosing an alternative but compatible set of format attributes that can broaden the pool of acceptable format attributes. In some cases, the interoperability of the format attributes themselves can limit such choices. Further, limitations of the various hardware elements within the digital cinema exhibition system can limit the choice of ancillary content titles as well. In addition, the exhibitor's policy may preclude certain ancillary content titles while preferring other such titles. For example, an exhibitor could choose to exclude an ancillary content title, which when displayed, appears too degraded. Also, an exhibitor could choose higher quality presentation format attributes that would allow certain compatible ancillary content titles to look better, even if the digital cinema feature presentation could not take advantage of the higher quality (but still compatible) set of format attributes.

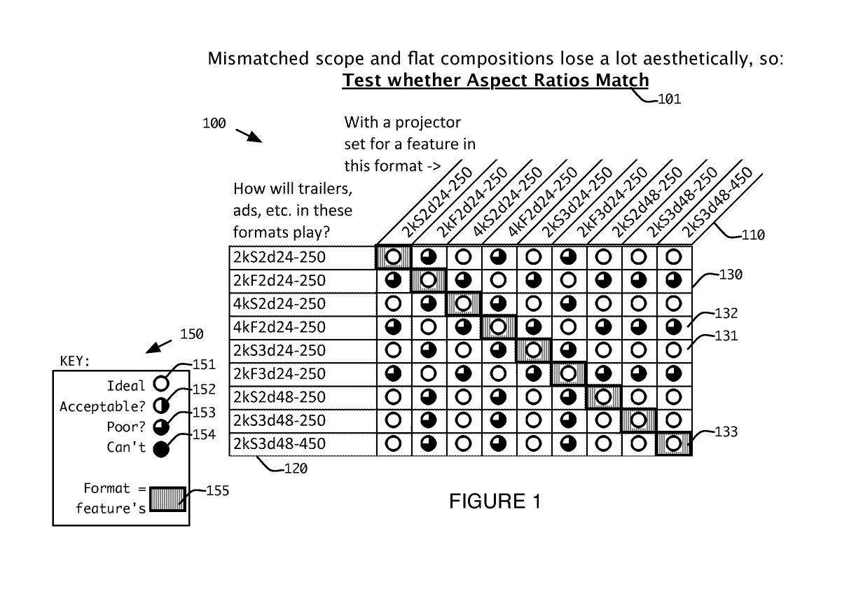

FIG. 1 shows a matrix where each of the axes 110 and 120 lists a like selection of digital cinema format attributes. The selection corresponds to those sets of format attributes a particular digital cinema exhibition system can accommodate. Here, the format names have the following encoding, used here for its simplicity:
Resolution: ‘2K’ or ‘4K’, where a 2K format constrains an image to a maximum of 2048 pixels horizontally and 1080 pixels vertically. (In other embodiments, additional resolutions might be included.)
Aspect Ratio: ‘F’ for flat, or ‘S’ for scope, where flat defines a 1.85:1 aspect ratio and scope defines a 2.39:1 aspect ratio. (In other embodiments, additional aspect ratios might be provided.)
Dimension ‘2D’ or ‘3D’, where a 3D presentation appears stereoscopic.
Frame Rate: ‘24’ or ‘48’ specifies a 24 fps or 48 fps frame rate for the content. (In other embodiments, additional frame rates, e.g., 60 fps) might be provided.)
Bandwidth ‘250’ or ‘450’ indicates the bandwidth (peak bit rate) of the content constrained during compression, in megabits per second. The 250 Mb/s value represents the original standard constraint for digital cinema features, whereas the 450 Mb/s represents a more recently introduced constraint to improve or maintain quality at higher frame rates or higher resolutions. (In other embodiments, additional bandwidths might be provided.)
In still other embodiments, metadata regarding the content might further comprise an indication of the audio format, not used in the examples herein.
   For each digital cinema feature and each ancillary content title, metadata accompanying such content describes the set of associated format attributes. By examining and comparing such metadata, the format attributes of the digital cinema feature and ancillary content title can undergo compatibility testing in the manner described hereinafter.

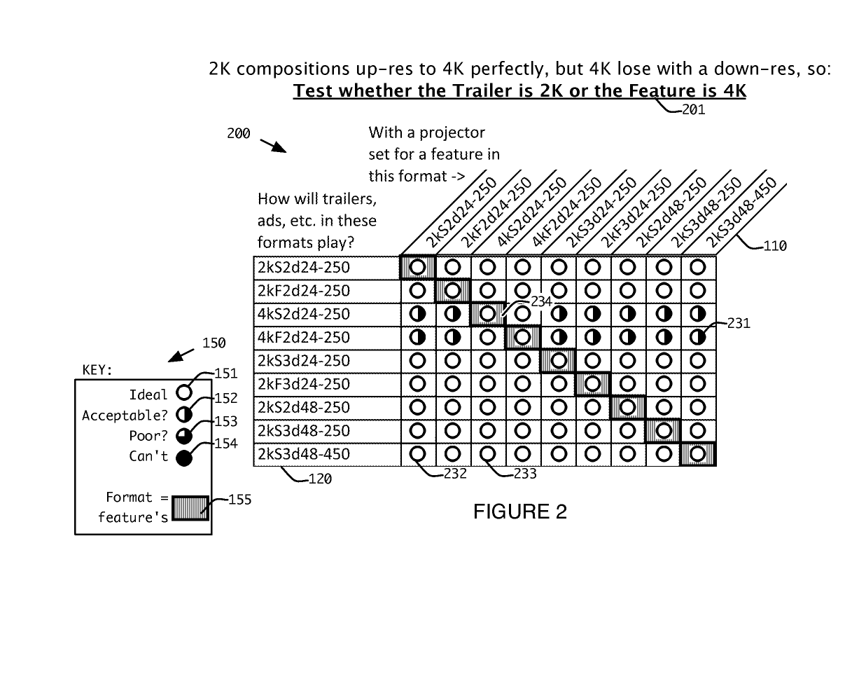

Thus, in FIG. 1, the first set of format attributes appearing along the axis 110 bears the designation ‘2kS2d24-250’, which indicates a digital cinema feature encoded for a 2048×1080 maximum resolution, a scope aspect ratio (thus further limiting the picture extent to 1998×1080 pixels), a 2D (non-stereoscopic) format at 24 frames per second and not exceeding 250 Mb/s bandwidth. In the compatibility matrix 100, and in those matrices that appear in FIGS. 2-6, each column corresponds to the set of format attributes in which the digital cinema feature will undergo play out for display, as labeled by the horizontal axis 110. Each row corresponds to the set of format attributes of the originally delivered ancillary content title (e.g., trailer and/or advertisement). Each cell of the matrix 130 indicates the presentation quality level (e.g., the condition of expected play out) of the ancillary content title using the corresponding digital cinema feature play out set of format attributes, considering only a first test 101, “whether the aspect ratios match.”

A digital cinema presentation will generally have either a ‘flat’ or ‘scope’ aspect ratio. If a trailer comprising part of an ancillary content title having a ‘flat’ aspect ratio undergoes display in a ‘scope’ aspect ratio, the top and bottom of the image will likely appear cut off, or blank columns will appear at the sides of the image, or both, because scope constitutes a wider aspect ratio than flat. If a trailer comprising part of an ancillary content title having a scope aspect ratio undergoes display in a flat aspect ratio, the right and left sides of the image may appear cut off, or blank bars can appear at the top and bottom, or both, again, because scope constitutes a wider aspect ratio that flat.

The type and severity of the degradation will depend on the particular equipment comprising the digital cinema exhibition system, and its configuration. A particular exhibitors' equipment configuration could produce results not terribly different in one aspect ratio or the other. For example, an exhibitor could choose not to mask the screen according to the aspect ratio. In addition, the degradation may not appear symmetric—i.e. a flat image projected in a scope aspect ratio format may not appear as bad as a scope image projected in a flat aspect ratio. As a result, individual exhibitors could have a matrix 100 that differs from the example shown in FIG. 1.

The key 150 in FIG. 1 depicts an exemplary set of symbols used to populate the matrix 110 (as well as each of the matrices in FIGS. 2-6). In these matrices, a cell for which the format attributes of the feature presentation, when applied to the ancillary content title, yields a display of the ancillary content title that is as good as possible, the ‘IDEAL’ icon 151 (a white-filled circle) will indicate that condition (quality level). If the application of the set of format attributes of the digital cinema feature to the ancillary content title yields a somewhat degraded display, the ‘ACCEPTABLE’ icon 152 (half-white/half-black circle) will indicate that condition. If the result yields a heavily degraded presentation of the ancillary content title, the ‘POOR’ icon 153 (¾ black circle) will indicate that condition. If ancillary content title cannot undergo display at all using the set of format attributes of the digital cinema feature, then “CAN'T” icon 154 (all black circle) will indicate that condition. The cells along the diagonal of the matrix (where the two set of format attributes have identical values) get marked with the background hash 155 for universal filling with the ‘IDEAL’ icon 151 as in cell 133.

As an example, the ‘IDEAL’ icon 151 appears in the cell 131 because, with respect to the test 101, both the format attribute of the feature (2kS3d48-450) and the format attribute of the ancillary content title (2kS3d24-250) use the scope aspect ratio, which will yield a presentation as good as possible. The cell 132 contains the ‘POOR’ icon 153, because for this set of format attributes associated with the digital cinema feature, the format attributes of the ancillary content title (4kF2d24-250) indicate a different aspect ratio. In this example, for this particular exhibitor's configuration, the quality of an ancillary content title played out in a scope aspect ratio will likely appear heavily degraded, that is, the audience would likely find the presentation objectionable and of low quality. However, the equipment will actually play out if required to do so, and the low quality comes from either the poor presentation quality that results, or the long delay required for the system to change formats so that the presentation can occur (regardless of the final quality when play out does occur). In this example, the assessment is symmetrical: An ancillary content title having a flat aspect ratio playing out in the scope aspect ratio will appear equally as poor as an ancillary content title having a scope aspect ratio playing in a flat aspect ratio, but individual exhibitors could assign different assessments, which might not be symmetrical.

FIG. 2 shows a matrix 200 similar to the matrix 100 of FIG. 1 with the matrix 200 encoding the quality of each ancillary content title playing out in the set of format attributes associated with the digital cinema feature considering only the test 201: “whether the ancillary content title has a 2K resolution or the digital cinema feature presentation has a 4K resolution.”

The test 201 has four possible outcomes:
a) an ancillary content title having a 2K resolution looks fine when played out with 2K resolution,
b) an ancillary content title, having a 2K resolution, looks great after undergoing a resolution upgrade for 4K play out,
c) an ancillary content title having a 4K resolution trailer would look great playing in a 4K presentation format, but
d) a 4K trailer playing in a 2K presentation format would suffer some degradation but would not appear sufficiently objectionable as to preclude play out.

Thus, for case (d), for which the test stated would yield less than ideal results, the ‘ACCEPTABLE’ icon 152 will designate that condition (as in the cell 231 of FIG. 2); whereas the cells corresponding to conditions (a), (b) and (c) (e.g., the cells 232, 233, and 234) all contain the ‘IDEAL’ icon 151 to indicate the corresponding condition. For some exhibitors, the assessment of condition (b) could yield a different result if policy dictates that the ancillary content title should not look better than the digital cinema feature. Were that the case, the test 201 would have different criterion and the cells of the matrix 200 would undergo evaluation accordingly.

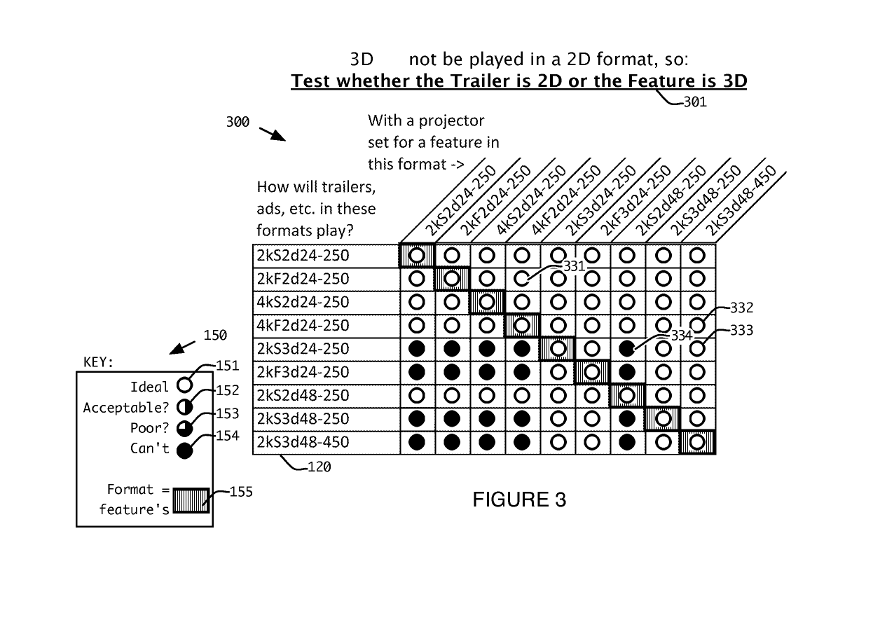

FIG. 3 shows a matrix 300 similar to the matrices 100 and 200 of FIGS. 1 and 2, respectively. The matrix 300 of FIG. 3 encodes the quality of each ancillary content title playing out with the same set of format attributes as the digital cinema feature presentation considering only the test 301: “whether the ancillary content title has a 2D format or the feature presentation format has a 3D format.” The test 301 has three successful outcomes:
a) the digital cinema feature presentation has a 2D format and the ancillary content title has a 3D format represented by the condition indicated in the cell 331,
b) the digital cinema feature presentation has a 3D format and the ancillary content title has a 2D format, as represented by the condition indicated in the cell 331, since most servers allow 2D content to undergo display in a 3D mode, and
c) the digital cinema feature presentation and the ancillary content title format both have a 3D format, as represented by the condition indicated in the cell 333.

The test has an unsuccessful outcome for a fourth case (d) where the digital cinema feature presentation has a 2D format and the ancillary content title has a 3D format, as represented by the condition indicated in the cell 334 marked with a “CAN'T” icon 154, because servers do not generally support choosing one or the other eye views in a stereoscopic presentation for display as a 2D presentation. This condition does not represent a technical impossibility. Rather, most content creators do not want automatic reprocessing their composition and display of the automatically generated results in this way. Various artifacts appear visible in a single-eye view presentation of such content that do not become apparent when presented stereoscopically, for example the black bars of a floating window necessitated when objects at or near the edge of the screen should appear in front of the screen.

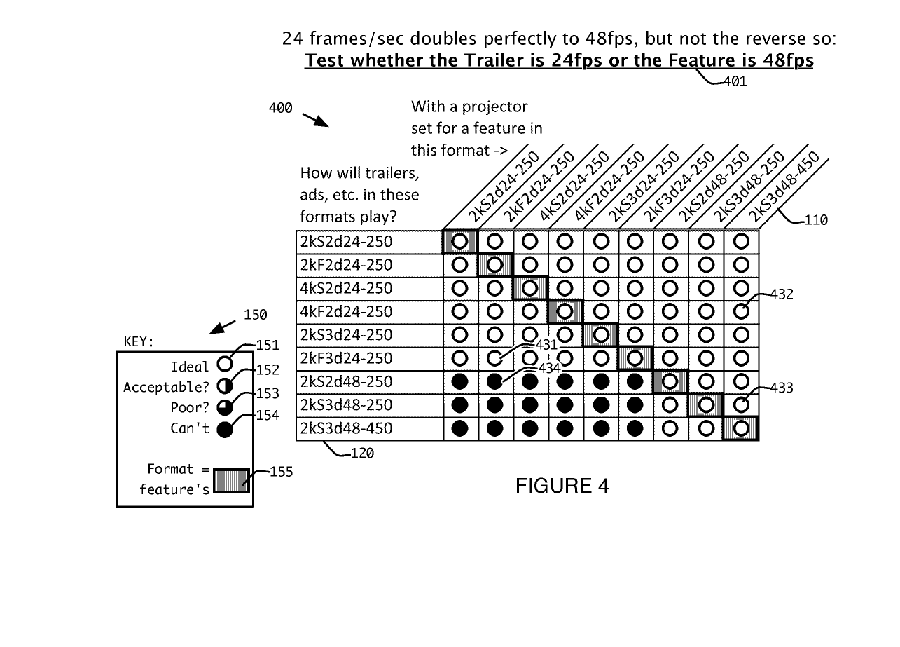

FIG. 4 shows a matrix 400 similar to the matrices 100, 200, and 300 of FIGS. 1, 2, and 3, respectively. The matrix 400 of FIG. 4 encodes the quality of each ancillary content title playing out using the same set of format attributes associated with the digital cinema feature considering only the test 401 “whether the ancillary content title format has a frame rate of 24 frames per second, or whether the digital cinema feature presentation has a frame rate of is 48 frames per second.” The test 401 has three successful outcomes:
(a) the ancillary content title and digital cinema feature presentation both have a frame rate of 24 fps, as represented by the condition indicated in the cell 431,
(b) the ancillary content title and feature presentation both have a frame rate of 48 fps, as represented by the condition indicated in the cell 433, and
(c) where the ancillary content title format has a frame rate of 24 fps and the digital cinema feature presentation has a frame rate of 48 fps, as represented by the condition indicated in the cell 432, because a frame-doubled play out of the ancillary content title, at least for the exemplary assessment, loses no quality when frame doubled.

However, the test 401 yields an unsuccessful outcome for a fourth condition (d) when the digital cinema feature presentation has a frame rate of 24 fps and the ancillary content title has a frame rate of 48 fps, as represented by the condition indicated in the cell 434. Under such circumstances, the “CAN'T” icon 154 indicates the failed result. Most digital cinema equipment generally cannot support dropping alternate frames from a digital cinema feature, a condition not considered viable. In other embodiments, such frame skipping could occur, though the results would incur a substantial degradation in quality from what was intended. Under such circumstances, the cell 434 would contain the “POOR” icon 153.

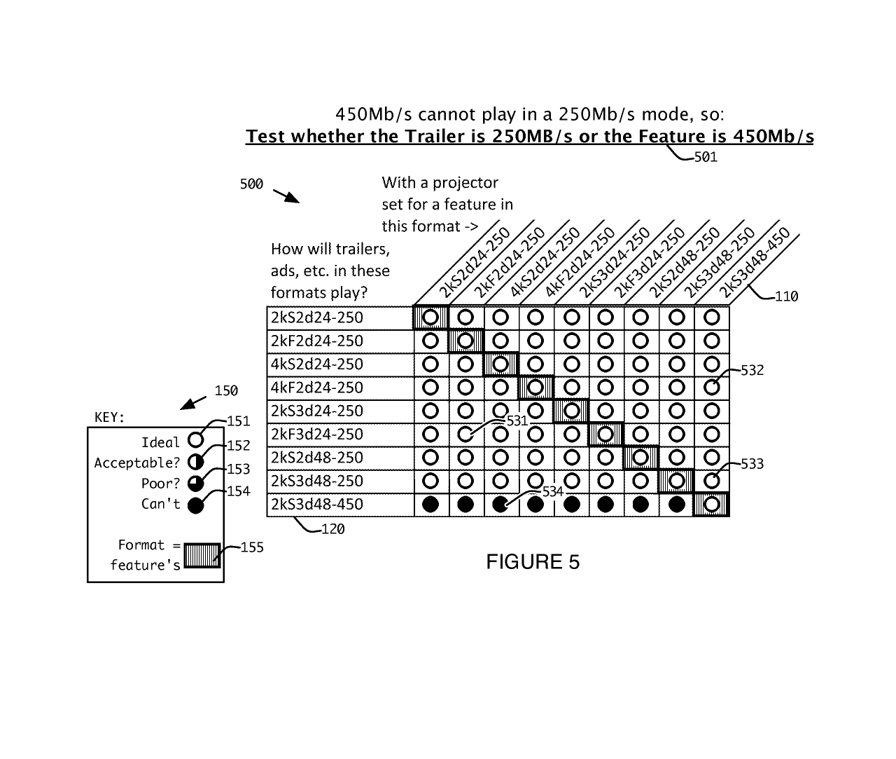

FIG. 5 shows a matrix 500 similar to the matrices 100, 200, 300, and 400 of FIGS. 1, 2, 3, and 4, respectively. The matrix 500 of FIG. 5 encodes the quality of each an ancillary content title playing out using the same set of format attributes as the digital cinema feature considering only the test 501 which considers the compatibility of the peak bit rate of the ancillary content title with that of the digital cinema feature. As a practical matter, the test 501 evaluates whether the ancillary content title requires peak data rates no greater than 250 Mb/s or the digital cinema feature supports peak data rates of up to 450 Mb/s.” The test 501 has three successful outcomes:

a) both the ancillary content title and the digital cinema feature have a peak bit rate of 250 Mb/s or less, as represented by the condition indicated in the cell 531.

b) the ancillary content title has a peak bit rate not greater than 250 Mb/s but the digital cinema feature has a peak bit rate as high as 450 Mb/s as represented by the condition indicated in the cell 532, and

c) both the ancillary content title and the digital cinema feature have peak bit rates up to 450 Mb/s as represented by the condition indicated in the cell 533.

The test 501 has an unsuccessful outcome for a fourth condition (d) that occurs when ancillary content title has a peak bit rate higher than 250 Mb/s and as high as 450 Mb/s, but the digital cinema feature has a peak bit rate constrained not to exceed 250 Mb/s, as represented by the condition indicated in the cell 534. Some exhibitor's digital cinema exhibition systems will not support peak bit rates as high as 450 Mb/s for any content, whether a digital cinema feature or an ancillary content title. Under such circumstances, the last row and column of matrix 500 contain “CAN'T” icons 154. Other exhibitor systems capable of peak bit rates 450 Mb/s would not treat digital cinema features and ancillary content title differently, regardless of the bandwidth requirements of the digital cinema feature. Under such circumstances all cells matrix 500 would contain the “IDEAL” icon 151.

The complexity of the matrices 100, 200, 300, 400, and 500 of FIGS. 1-5, respectively, will increase if a need to exists to consider more format attributes, for example higher frame rates, e.g., 60 and 120 fps as well as higher resolutions such as adding 8K to the present menu of 2K and 4K, etc. For ease of discussion, the matrices 100, 200, 300, 400 and 500 of FIGS. 1-5, respectively, have been simplified and do not incorporating such enlargements. To the extent that consideration of additional format attributes becomes necessary, for example, the adoption of higher frame rates, such additional format attributes would be added along the axes 110 and 120 of FIGS. 1-6.

Similarly, different audio formats could undergo examination as well to differentiate between a set of format attributes offering a basic 5.1 audio format (left, center, and right, all behind the screen; a left- and right-surround on the walls of the theatre; and a low-frequency effects channel, i.e., the “0.1”) and more elaborate predetermined configurations (e.g., audio formats necessitating the placement of additional speakers behind the screen, around the room, and/or on the ceiling). Since the limitations and requirements of audio formats remain generally orthogonal to picture formats, the process of evaluating the compatibility the audio format attributes of an ancillary content title with those of a digital cinema feature would require the addition of a separate set of matrices (not shown) for the audio formats of the ancillary content title and the audio formats of the digital cinema feature. The management and application of such audio format matrices would occur in manner similar to that described herein for picture format matrices. Presently, the need for implementing the technique of the present principles for differing audio formats remains relatively low. Few if any ancillary content titles exist in an audio format more sophisticated than the 5.1 format described. Further, all higher quality audio formats support the 5.1 audio format very well, if not ideally.

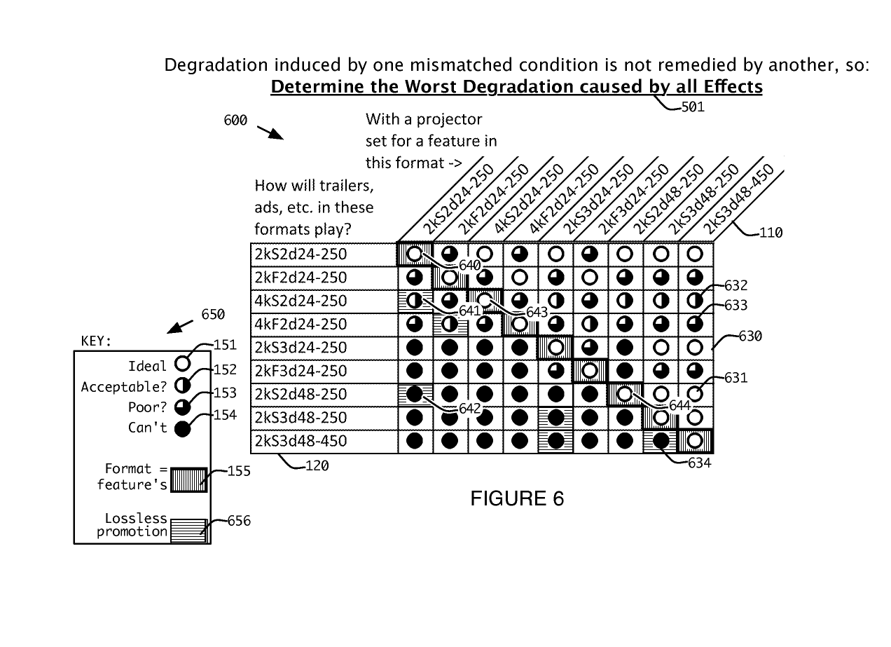

FIG. 6 shows a matrix 600 whose cells accumulate the results from each of the tests 101, 201, 301, 401, and 501 for the corresponding matrices 100, 200, 300, 400 and 500, respectively of FIGS. 1-5, respectively. Since the degradations identified by the tests 101, 201, 301, 401, and 501 remain independent of the other tested conditions, the net assessment for any cell in any matrix remains no worse than the worst assessment for the cells of all the tests of all of the matrices (though, in other embodiments, personnel who implement the play list creation technique of the present principles could choose to treat degradations within the various test matrices as cumulative). Taking the lowest quality assessment in any of the cells corresponding to the same position in each of the matrices 100, 200, 300, 400, and 500 represents a suitable approach to consolidating the results of the tests 101, 201, 301, 401, and 501, respectively.

As an example, consider when the cell 132 in matrix 100 indicates a “POOR” condition arising from an aspect ratio mismatch. The corresponding cell 232 in the matrix 200 will indicate an “ACCEPTABLE” condition that would result from the play out of 4K content at 2K. The corresponding cell 332 in the matrix 300 indicates an “IDEAL” condition arising from 2D content playing just fine in 3D (for the system under consideration). The corresponding cell 432 in matrix 400 of FIG. 4 indicates an “IDEAL” condition since 24 fps content plays fine at 48 fps by frame doubling (for the system under consideration). Lastly, the corresponding cell 532 in matrix 500 of FIG. 5 indicates an “IDEAL” condition as well since content having a peak bit rate of 250 Mb/s will play out well when the system has the capability of supporting a peak bit rate of 450 Mb/s.

The lowest assessment among these corresponding cells constitutes the “POOR” condition indicated in the cell 132 of matrix 100 of FIG. 1. Therefore, the corresponding cell 633 in the matrix 600 of FIG. 6 receives this assessment. Based on the lowest assessment among the cells of the five evaluation matrices 100, 200, 300, 400, and 500, some cells in the matrix 600 will indicate an “IDEAL” condition (e.g., cell 631). Other cells will indicate an “ACCEPTABLE” condition (e.g., cell 632), with some cells indicating “POOR” condition (e.g., cell 633). Lastly, some cells will indicate a “CAN'T” condition (e.g., cell 634).

The key 650 for the matrix 600 comprises the original key 150 as well as a hash pattern 656, denoting cells such as cells 641 and, 642 which represent a lossless promotion path from the identity cell 640 in the same column. A lossless cell indicates content can that can play out with no degradation in quality. The cells in the matrices of FIGS. 1-6 marked with the hash 155 comprise identity cells, lying on the diagonal of each matrix, constituting those cells for which the ancillary content title has exactly the same set of format attributes as the digital cinema feature. For the format attributes of the digital cinema feature of the first matrix column (2kS2d24-250), only ancillary content title having the same set of format attributes will play out ideally, since for that set of format attributes, only the identity cell 640 has the “IDEAL” condition 151. Considering the other sets of format attributes for the ancillary content title (2kF2d24-250, 4kS2d24-250, and 4kF2d24-250) that would allow play out at all, two sets of format attributes would give rise to “POOR” conditions and a remaining set of format attributes merely indicates an “ACCEPTABLE” condition. The lossless promotion hash 656 in cells 641 and 642 of matrix 600 of FIG. 6 indicates two enhanced set of format attributes usable as the set of format attributes for play out of the digital cinema feature with no loss in quality relative to the set of format attributes corresponding to the column containing the lossless promotion cells 641 and 642 for the equipment considered.

Each of the lossless promotion cells 641 and 642 of FIG. 6 offers a different enhancement: The first, cell 641, suggests configuring the resolution as 4K, rather than 2K. Travelling horizontally to the identity cell 643 (corresponding to lossless promotion cell 641) identifies the resulting column this first lossless promotion offers. In this cell, the ancillary content title format attributes rated “POOR” have not changed, but the format attribute rated “ACCEPTABLE” climbs to an “IDEAL” condition (e.g., condition depicted in cell 643). A digital cinema exhibition system configured to accept 4K will play out a 2K feature, but now, 4K ancillary content file titles will play out in a 4K resolution, rather than being reduced to 2K resolution. For some digital cinema equipment, moving to a 4K resolution can represent a reduction in quality, which if applied to the digital cinema feature, would not yield a lossless promotion′. For this example, the consideration is that promotion of the presentation format from 2K to 4K is lossless.)

The second lossless promotion cell in the first column, 642, suggests configuring the digital cinema feature for 48 fps rather than 24 fps. Travelling horizontally to the identity cell 644 (corresponding to lossless promotion cell 641) identifies the resulting column this second lossless promotion offers. In that cell, the ancillary content title formats attributes rated “POOR” have not changed, nor has the one rated “ACCEPTABLE.” However, an ancillary content title format attribute previously rated “CAN'T” (the format attribute depicted by cells 642 and 644) now indicates an “IDEAL” condition. Thus, an ancillary content title previously not capable of display at all when the digital cinema feature has a feature attribute set corresponding to 2kS2D24-250 will display perfectly by promoting the digital cinema feature format attributes to 2kS2D48-250. (Again, this promotion assumes equipment capable of play out of 24 fps content at a 48 fps mode via frame doubling, thus constituting a lossless promotion.)

Some promotions, while technically feasible, remain inappropriate. For example, a 2D feature presentation format could get promoted to a corresponding 3D feature presentation format. This would allow the presentation of 3D ancillary content titles, even though the digital cinema feature would constitute a 2D movie shown using a 3D presentation format. This promotion is improper for two reasons: First, since the digital cinema feature originally did not have a 3D format, the audience would not have received 3D glasses almost always necessary for today's 3D theatres. Second, most presentations of 2D content in 3D appear dimmer than in 2D. Thus, promoting content in this manner gives rise to losses (though some might debate whether the resulting dimmer image would constitute an “ACCEPTABLE” or a “POOR” condition.)

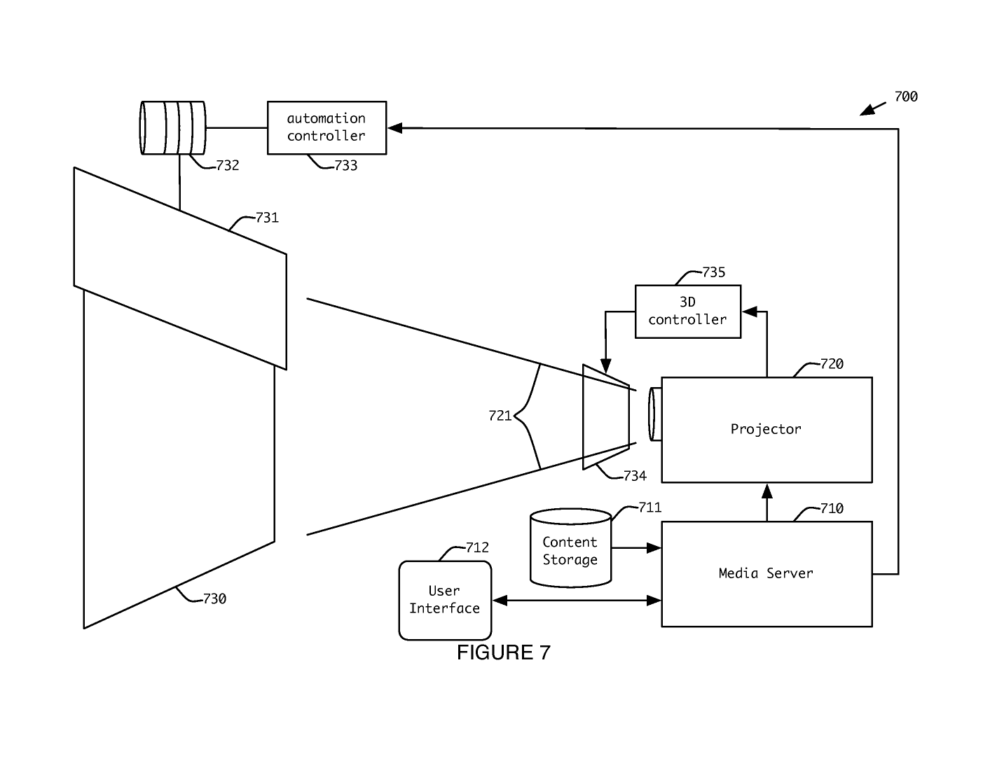

FIG. 7 shows a block diagram of a typical digital cinema exhibition system 700 for practicing the improved playlist selection technique of the present principles. The digital cinema exhibition system 700 includes a media server 710 responsive to a user interface 712 via which an operator can select content for inclusion in a playlist and start the play out of that list manually, or to schedule that playlist for future play out. Typically, the user interface 712 can include a computer terminal, or other mechanism through which an operator can enter commands to, and view a display of information from, the media server 710. A content storage mechanism 711 stores content (e.g., digital cinema features and ancillary content titles) for receipt by, and play out from, the media server 710. The content storage mechanism 711 also provides a list of available content (which can include content which available but not yet loaded onto the content storage mechanism) for use in building a playlist.

During content play out, the media server 710 will provide control information and digital cinema images to a digital cinema projector 720: The media server 710 can command the digital cinema projector 720 to display the digital cinema image with different format attributes as discussed above, either via explicit, individual commands, or by calling for specific macros previously defined in the projector. The media server 710 can also command an automation controller 733, which for example, controls a motor 732, to adjust screen-masking 731 to alter the aspect ratio of the visible portion of a screen 730.

Generally, the projector 720 manages a 3D controller 735, if present. In some embodiments, the automation controller 733 could manage the 3D controller 735 instead. When active, the 3D controller inserts a 3D modulator 734 into the light path 721 of the digital cinema projector 720 and synchronizes the modulator with the projector image output. As shown, the 3D modulator 734 resides outside of the digital cinema projector 720, though in some embodiments the modulator could reside inside the projector. In still other embodiments, a 3D modulator can reside on glasses worn by members of the audience. Under such circumstances, the 3D controller 735 will constitute an infrared or radio frequency emitter to control the 3D modulator on the glasses to synchronize the modulator with the digital cinema projector 720. In some embodiments where the 3D modulator 734 mounts on the digital cinema projector 720, the modulator cannot be automatically inserted or removed from the light path, instead requiring a manual, mechanical intervention. This remains the case for digital cinema projectors that use a dual-lens attachment or dual projector systems, in contrast to a single projector-3D modulator combination.

For a digital cinema exhibition system that has no ability to switch automatically between 2D and 3D modes, the 3D presentations will likely only occur when the digital cinema features being presented exist in 3D. Even if the digital cinema projector 710 can automatically switch between 2D and 3D, this process takes time, typically tens of seconds, thus constituting an unsuitable delay for some theatrical presentations. In some cases, switching between different frame rates requires a delay because the 3D controller 735 and/or 3D modulator 734 requires time to synchronize to a change in the frame rate. For some equipment, especially those involving mechanical modulators, the time for synchronization can take tens of seconds. These issues other equipment-specific matters require consideration when setting the assessment tests (e.g., the tests 101, 201, 301, 401, and 501) for populating the matrices 100, 200, 300, 400, and 500, respectively.

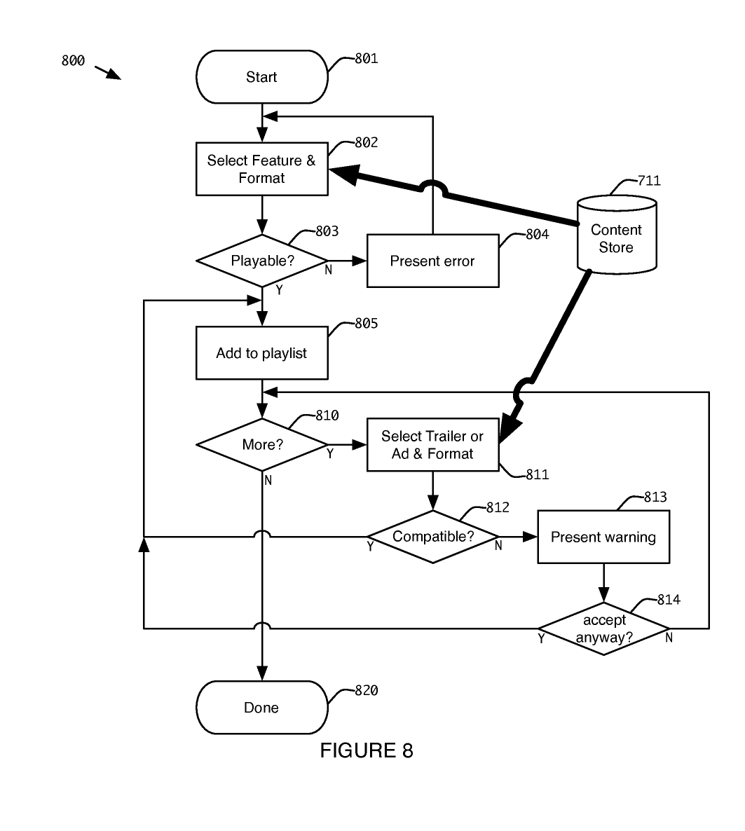

FIG. 8 depicts a playlist creation process 800 in accordance with a first embodiment of the present principles for execution by the media server 710 of FIG. 7. Execution of the process 800 commences with start step 801 during which the content storage mechanism 711 gets populated with a list of available content. During the start step, the media server 710 will also determine the set or sets of feature attributes supported by the digital cinema exhibition system 700 and establish metadata representing such information. Alternatively, the media server 700 could be pre-populated with such metadata. During step 802, an operator will select a digital cinema feature with a specific set of format attributes suitable for display by the digital cinema exhibition system 700 of FIG. 7.

In one exemplary embodiment, the content selection step 802 may be performed through the user interface 712 displaying to the operator:

“Funny-Movie_FTR_S_EN-XX_US-PG_{—}51-EN_{—}2K_FX_{—}20120615_TEC_OV” and

“Funny-Movie_FTR_S_EN-XXUS-PG_{—}51-EN_{—}2KFX_{—}20120615_TEC_i3D_OV”,

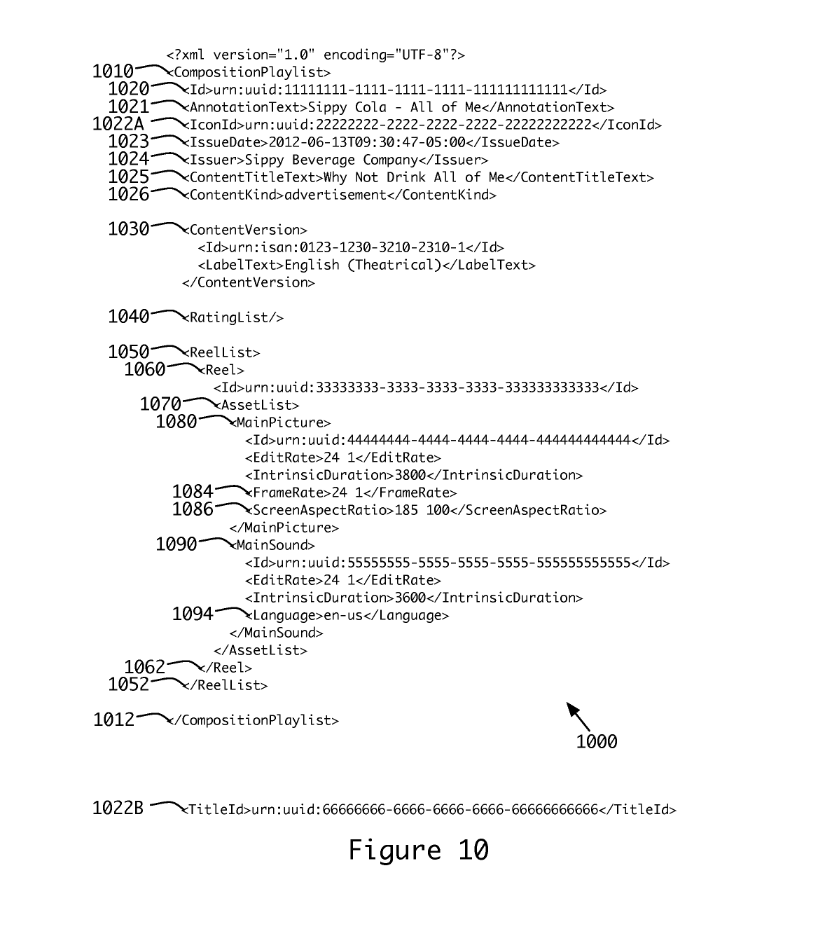

two distinct pieces of content that correspond to the same movie, but which have different format attributes, the latter being in 3D. A selection of the former corresponds to the format attribute set 2kS2d24-250, corresponding to the format attribute set of the first column of the matrix 600 of FIG. 6. In practice, media server 710 obtains the format attributes of digital feature by reading metadata representative of such format attributes carried by the digital cinema feature as discussed in conjunction with FIG. 10. During step 803 of FIG. 8, the media server 710 determines whether the selected digital cinema feature can undergo play out using the selected set of format attributes.

In making this determination, the media server 710 of FIG. 7 uses the format attribute set of the digital cinema feature to select the row (rather than column) in summary matrix 600, where at least one column is available, representing the set of available format attribute combinations supported by the system 700 of FIG. 7. The media server 710 then examines the corresponding at least one cell at the intersection of the matrix row and each at least one column. So long as the summary rating for that at least one cell provides other than a “CAN'T” condition, the process 800 of FIG. 8 proceeds to step 805. However, if all of the at least one cells indicate a “CAN'T” condition, then step 804 occurs to alert the operator of the error (e.g., through user interface 712): The digital cinema exhibition system 700 cannot play the feature in the selected format. The process 800 then returns to step 802 so the operator can correct the selections. In some embodiments, the determination (e.g., testing) undertaken by the media server 710 during step 803 can enforce other policies. For example, an exhibitor or equipment manufacturer may require either an “IDEAL” or “ACCEPTABLE” condition exist at step 803 before proceeding to step 805.

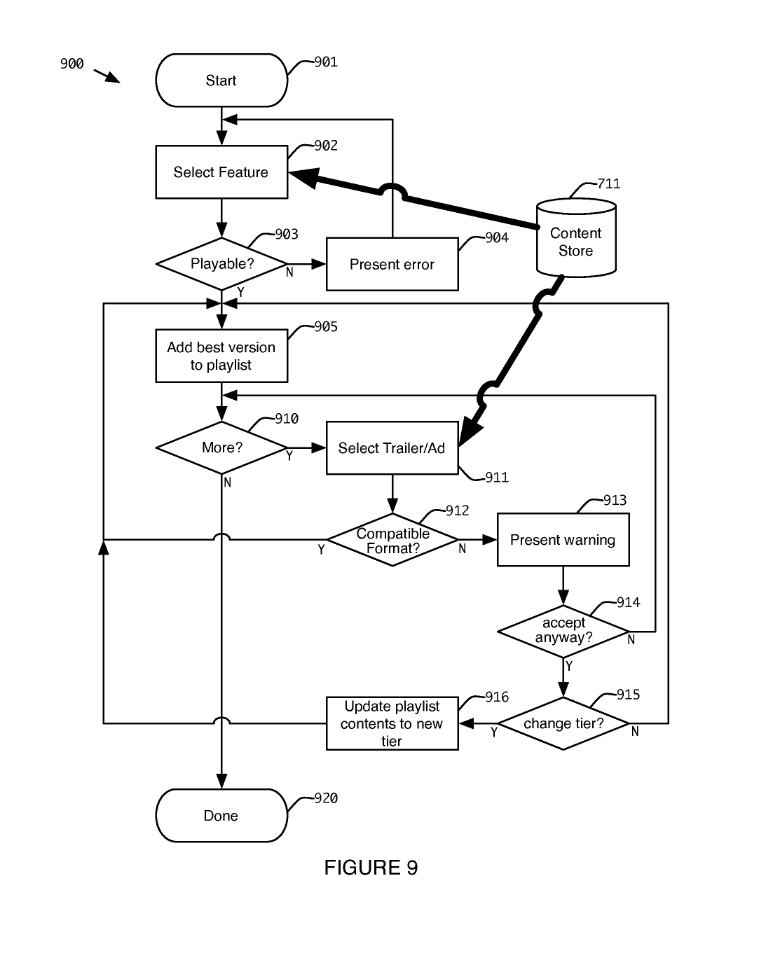

In other embodiments, of process 800, the selection of the format in which a selected feature is to be played may be made automatically, as discussed below in conjunction with step 903 of FIG. 9.

Other well-known factors can influence the ability to play out a selected digital cinema feature. For example, most digital cinema features undergo encryption prior to storage in the content storage mechanism 711 of FIG. 7. An encrypted digital cinema presentation will only play out in a useful manner if decrypted by the media server 710 of FIG. 7 (and in some cases in combination with the projector 720) using a decryption key valid for the interval when play out would occur. The availability of such a key can contribute to the decision of whether or not a digital cinema can undergo play out now or in the near future during step 803.

In cases where the digital cinema feature should play out in the future, or remains playable in with its current set of format attributes, but at less than an “IDEAL” quality, the media server 710 could generate an appropriate warning during step 804. Depending upon policy, the media server 710 could optionally ignore the warning and proceed to step 805. If digital cinema feature can undergo play out on the basis of the format attributes selected for the digital cinema equipment to undertake the play out, then during step 805 of FIG. 8, the media server 710 of FIG. 7 will add that digital cinema feature with its corresponding attributes to the playlist.

During step 810 of the process 800 of FIG. 8, the media server 710 determines whether the operator considers the playlist complete. Typically, the media server undertakes such a test by directing an appropriate query to the operator through the user interface 712 of FIG. 7. If the operator deems play list creation complete, then the media server 710 ends the playlist creation process at step 820. The media server 710 will then save the play list or immediately load it to commence play out now or at a future time. However, if during step 805, the operator indicates the need to add more content, such as ancillary content titles, to the playlist, the process 800 proceeds to step 811.

During step 811, the operator will make a selection of content, typically, although not necessarily, one or more ancillary content titles, from the content storage mechanism 711, again through user interface 712. During step 812 of FIG. 8, the media server 710 will test for the compatibility of the format attributes of the content selected during step 811 with the current setting for the format attributes of the digital cinema feature. To undertake the compatibility test during step 811, the media server 710 will examine the condition indicated in by the cell in the matrix 600 of FIG. 6 at the intersection of the matrix row corresponding to the format attributes of the selected content and matrix column corresponding to the format attributes of the digital cinema feature. (As with the compatibility testing of the digital cinema feature, the compatibility testing of the ancillary content title by the media server 710 includes establishing the format attributes of the ancillary content title from the associated metadata carried thereby.) If the cell at the intersection of these two columns indicates a IDEAL quality condition, the test conducted during step 812 has a successful outcome and processing proceeds back to step 805 during which, the media server 710 will add the selected ancillary content title to the playlist. However, if the matrix cell indicates other than an “IDEAL” condition, the test fails and the media server 710 will generate a warning during step 813.

Notwithstanding the warning generated during step 813, the process 800 allows the operator to override the warning during step 814, in which case, the media server 710 will add the selected ancillary content title to the playlist during step 805. If the operator does not override the warning, the media server 710 will discard the selected content and the process returns to step 810 for the opportunity to finish the playlist.

In some embodiments, the compatibility test undertaken during step 812 could impose less stringent requirements, automatically accepting content selections if the results of the compatibility test will yield at least an “ACCEPTABLE” quality level or condition, or even a “POOR” condition. For such embodiments, the content selections offered during step 811 must yield a “POOR” or better quality level, thereby removing from consideration any content that cannot undergo play out with its current format attributes (i.e., a “CAN'T” condition). In other embodiments, the content selections presented during step 811 can include those yielding a “CAN'T” condition, with the expectation that, if added to the playlist, such content will require a change to one or more of its format attributes to play out. During step 814 the operator can choose to ignore the warning that the necessary format change might cause a discontinuous or incomplete play out. In other words, play out of the content might undergo a delay while the undertaking the necessary changes to the format attributes. Thus, the audience might not view the selected content if play out proceeds before the changes in the format attributes can occur.

In some embodiments, the selection during step 811 of ancillary content titles might not include a specification of which format is to be used, but, as previously discussed with respect to playability test conducted during step 803, the compatibility determination made during step 812 might consecutively consider each format in which each selected ancillary content title is available, in order of descending preference. In this way, the most preferable format compatible with the feature format settings can be automatically selected for each selected ancillary content title, with the warning generated during step 813 coming only if there is no format for a selected ancillary content title that meets the sufficient compatibility requirements of step 812.

FIG. 9 depicts an alternative playlist creation process 900 in accordance with another embodiment of the present principles. Execution of the process 900 by the media server 710 of FIG. 7 commences with start step 901 during the content storage mechanism 711 gets populated with a list of available content. The list includes metadata that associates differently formatted versions of the same content titles (whether features, trailers, ads, etc.) so that the media server 710 need only present the content title to the operator. Thus, during the content selection step 902, the user interface 712 of FIG. 7 will display to the operator just the feature titles, whereas in content selection step 802 of FIG. 8, the operator was presented both the feature titles and the different formats in which each were available. Instead, during step 902, the user interface 712 can display just the movie title, “Funny Movie” and separately (if at all) indicate that both 2D and 3D versions, both in scope, are available. As with the process 800 of FIG. 8, the process 900 of FIG. 9 obtains the necessary format attributes from corresponding metadata.

The operator selects the desired content by title, and in response, the media server 710 executes step 903 to determine (i.e., test) whether the selected content exists in a form having format attributes supported by the digital cinema exhibition system 700 to enable content play out. If not, the media server 710 will generate an error message during step 904 and discard the content selection. However, if the selected title exists as content in one or more forms having format attributes supported by digital cinema exhibition system 700 of FIG. 7 to play out, then during step 905, the media server 710 will select the highest quality form of such content for addition to the playlist. In practice, the media server 710 selects the ‘highest quality’ form of the content by using a predetermined list of possible format attributes of the available forms of the selected content, sorted in order of preference, from the most preferred form to the least. For example, the media server 710 can establish a list in accordance with the order in which such format attributes appear along the axes 110 and 120 of the matrix 600 of FIG. 6. The axes 110 and 120 typically have an order that prefers a scope aspect ratio over flat, preferring 4K over 2K, preferring 3D over 4K, and preferring 48 fps over 3D. Each exhibitor would choose or provide such a ranking of format attributes, which may further vary, given the particular digital cinema equipment available, or the particular motion picture exhibition facility. For instance, in a particular facility, 3D might constitute the least desirable format attribute. A particular digital cinema exhibition system might not support 48 fps, thereby eliminating content having such frame rate from consideration for selection (rather than considering such content initially, but configuring the matrix 600 to reject such content during the playlist creation processes 800 and 900).

In some embodiments, the user interface 712 could provide the operator an indication during step 902 of the available titles as well as accepting a format preference, e.g., “in 3D”. Thus, during step 905, the media server 710 will select the best usable version of that content in 3D, rather than the “best usable version” of that same content, where some property of the content existing in a 2D format version might otherwise be considered in the predetermined sorted list as more important than the 3D format attribute. Thus, in an embodiment in which the media server 710 identifies a “2D, 48 fps” format as being preferable to a “3D, 24 fps” version of the same content, the format preference enables the media server to disregard (or at least, discount) any 2D formats, so that during step 905, selection of the best 3D format of the content occurs, if any are available.

During step 910, the media server determines if the operator has completed creation of the playlist. If so, the process 900 branches to step 920 indicating playlist creation has completed. Otherwise, during step 911, the media server 710 will present the operator with auxiliary content, for example, trailers and/or advertisements, listed by name. After selection by the operator, the media server executes step 912 to check for a version of the selected content having compatible format attributes. If at least one compatible version of the exists, then during step 905, the media server 710 selects the best compatible version of the selected content for addition to the playlist. If there is no version of the selected content exists having compatible format attributes, considering the policy established to define compatibility in accordance with a particular one of the permitted conditions (e.g., “IDEAL”, “ACCEPTABLE”, “or POOR”), the media server 710 will generate a warning during step 913. During step 914, the media server 710 will query the operator through the user interface 712 to test for acceptability of the selected content in spite of the warning. If not, then the media server 710 discards the content selection and processing loops back to step 910.

If after the warning given during step 913, the operator has entered an indication during step 914 to include the content anyway, then the media server 710 of FIG. 7 makes a determination during step 915 whether a) any lossless promotions (e.g., as marked by the hash 656) are available given the format attributes for the current digital cinema feature, and if available, b) whether such a lossless promotion would permit the selected content to play out at a quality level higher than the content that generated the warning, and if so, then c) presenting this option to the operator through user interface 712. If the operator accepts this option, the process 900 of FIG. 9 branches to step to 916, whereupon, the media server 710 of FIG. 7 updates the playlist to reflect the new format attributes corresponding to the lossless promotion. For each piece of content already admitted to the playlist, the media server 710 checks for a higher quality version (i.e., higher in the sorted format ranking, for example as suggested by the sorting of axes 110 and 120 of the matrix 600 of FIG. 6) that would play out with no worse quality than that already indicated by the appropriate one of the permitted conditions (e.g., “IDEAL”, “ACCEPTABLE”, “or POOR”).

After completing rework of the existing playlist and promoting the current digital cinema feature for the appropriate format attribute if necessary during step 916, the media server 710 will add the best version of the currently selected auxiliary content to the playlist during step 905. If during step 915, a) no lossless promotions exist, or b) they do not result in better play out for the selected content, or c) the operator does not allow it, the process will proceed directly from step 915 to step 905, at which time the media server 710 will add the selected content (for example, a selected ancillary content title), even though it will not play with the best quality. Here, too, if the resultant compatibility test yielded a “CAN'T” condition 154, then including the title in the playlist will force a format attribute change during the play out, so that content title undergoes display even though doing so induces a pause and/or glitch in the play out as the format settings of system 700 transition.

In order for the process 900 to better operate, especially the user interface activity during which an operator selects content by movie title, rather than a long format-ridden codename that describes all the attributes of the content, the composition playlist should incorporate an element that unambiguously identifies a composition as representing a particular title. The composition playlist constitutes a file that the lists the assets of a particular version of a movie, trailer, or ad, including the file(s) that provide the picture, the file(s) that provide the sound, the file(s) that provide the subtitles, and captions, and metadata defining how these files should play out, how fast, and when, so that the content plays out as intended, with all the elements in synchronization.

Currently, there exist widely adopted standards for composition playlists (CPL), for example the standard defined in the Society of Motion Picture and Television Engineers standards document 429-7-2006 D-Cinema Packaging. These standards provide that each CPL identifies itself with absolute uniqueness, using a UUID (universally unique identifier). No two CPLs should ever be created that have the same UUID value for the CPL ID. Separately, a CPL may also have a content version ID, which constitutes a UUID value, but which represents a particular set of attributes for a given title. Thus, a 2K, flat, 3D, 24 fps, 250 Mb/s CPL for a particular movie title (also having English as the main language, with French subtitles and other specific attributes), would receive a particular UUID. If that CPL undergoes an update, for example because of a need to correct the main titles or credits, or a specific scene gets re-edited to address some mistake or new artistic decision, the new CPL with its new, unique CPL ID would receive the same version ID that its predecessor had. The current standard for CPLs embodies the concept that “what the exhibitor/projectionist expected was a certain format, with certain languages in audio and captions, and this newer CPL constitutes an authoritative replacement for that one.” What is missing in current CPL formats is a unique identifier for a particular title, i.e., for a particular movie.

FIG. 10 shows a CPL 1000, substantially following the SMPTE 429-7 standard, with the omission of certain details (e.g., the designation of the SMPTE 429-7 namespace for certain elements), and the omission of most optional elements for conciseness and clarity. The composition playlist element starts at opening tag 1010 and runs through closing tag at location 1012. The unique CPL ID that refers precisely and exclusively to this CPL appears at the tag at location 1020. The annotation text element 1021 may be useful to readers of this file, or may be used in user interfaces. The icon ID at location 1022A is optional, and at present, is rarely used. Thus the icon ID tag can serve to identify a corresponding image resource, e.g., representing a thumbnail of the movie poster or other representation for this CPL in a graphic user interface. The date on which the CPL was created (issued) lies between the issue date tags at location 1023, and the issuer, that is the movie studio or advertising client, lies at the location 1024. The content title text, suitable for use in a user interface, lies at location 1025. The kind of content this CPL represents is identified at location 1026 (here, an ‘advertisement’, but ‘feature’ and ‘trailer’ are among the other canonical values). The rating list 1040, although required, can remain empty, as shown here.

The main parts of the CPL occur with the reel list 1050 (through tag 1052), within which consecutive, individual reels (only one shown here) each run between reel tags 1060 and 1062. Each reel has a unique identifier and an asset list 1070. The asset list enumerates the kinds and identifiers of resources for play out, and information about their synchronization. The main picture element 1080 identifies the 2D image files for display, the frame rate 1084 defines their play out rate (24 fps), screen aspect ratio 1086 determines whether the composition is flat or scope (here, flat). Main sound 1090 identifies the sound files for play out, and the language indicator 1094 names the primary spoken language for the dialog in the soundtrack. For content in a 3D format, a Main Stereoscopic Picture element (not shown) is supplied following the Main Sound, in lieu of having the Main Picture element 1080.

The content version identifier appears at location 1030. In the illustrated embodiment, the content version identifier constitutes an ISAN (International Standard Audiovisual Number) value, rather than a UUID as discussed above (though a UUID is acceptable). Another conventionally used kind of value for this version ID is a UMID (SMPTE's Unique Material Identifier). Of these, only the ISAN value offers the property that a defined portion of the ISAN value remains consistent across all instances of the same movie title, e.g., “Gone with the Wind (1939)”, whether that be a digital version of the original film, or a shortened version designed to play in 100 minutes, or a 3D conversion made to capture modern audience.

As a content title for a particular feature, “Gone with the Wind” might serve adequately for human readable text. Standard CPL formats seem to expect titles like this to appear in their ContentTitleText element. However, in a time before metadata is pervasively populated and sufficiently developed user interfaces have yet to be built, the ContentTitleText element has become augmented with many kinds of format information, which compromises the opportunity for a common identifier among all versions and formats of a title.

While any of the ContentTitleText element 1025, IconID element 1022A, or ContentVersion ID 1030 (if an ISAN value) could be populated to provide the same value for all instances and versions of the same movie title (or trailer, or ad), that does not presently occur. The closest would be if the content version ID 1030 were constrained always to be an ISAN value for which at least the core work portion would identify the title with which the CPL is associated. Note that a trailer for a feature might have the same core work value, but could be differentiated from each other by the content kind element 1026 (useful for automatically ensuring that a trailer for a movie doesn't appear in the same playlist as the movie itself), yet still offer a similar title-centric reference for the trailer & feature.

Alternatively, a new Title ID tag 1022B might be introduced into the CPL, and might be a UUID, an ISAN, or a truncated ISAN including only the core work portion, that is, the registered root portion of an ISAN value that includes no episode or version codes. In some embodiments, the episode number might be included (e.g., if used to distinguish sequels from the original). An advantage of the UUID is that no registration for the value is required: A content creator can generate a UUID value on their own, and use that value as needed (much as with the ISAN core work portion), without relying on a third party intervention. This may be better than relying on an Icon Id, since a content creator might eventually change icons or choose different icons for different versions of the feature (e.g., if the icon were to resemble the movie poster, then different language versions might appear differently, also movie posters may be updated or replaced over time, leading to further changes).

For a CPL to offer the metadata, such as title identity 1022B that provides definitive association to a common title, would help in the process of automatically choosing a suitable format attribute set (e.g., selected during step 912) for a selected title (e.g., selected during step 911), and would also help in the updating of playlist content to a higher quality presentation format attribute set (as during step 916). However, other sources for the association can be used: e.g., icon identifier 1022A, and portions of some content version identifiers (identifier 1030, especially when ISAN is used) and some presentations of content title text 1025 or annotation text 1021 (e.g., those that use a generally consistent, automatically parsable naming conventions)

The foregoing describes a technique for creating a play list for digital cinema presentation to assure compatibility of the format attributes of the content specified by the play list.

1. A method for selecting a digital ancillary content title for presentation with a digital feature, comprising the steps of:
(a) determining a first set of format attributes associated with the digital feature;
(b) selecting a first digital ancillary content corresponding to the digital ancillary content title, the first digital ancillary content having a second set of format attributes at least compatible with the first set; otherwise,
(c) if no digital ancillary content corresponding to the digital ancillary content title has format attributes at least compatible with the first set, then generating a warning.

2. The method of claim 1 wherein step of determining the first set of format attributes includes the step of examining metadata associated with the digital cinema feature.

3. The method of claim 1 wherein the step of selecting the first content includes the step of examining metadata associated with the first digital ancillary content.

4. The method according to claim 1 wherein the selecting step further comprises the step of:
identifying at least the first digital ancillary content and a second digital ancillary content, both corresponding to the digital ancillary content title, the second digital ancillary title content corresponding to the digital ancillary content title and having a third set of format attributes, the third set compatible with the first set; and
selecting among the first and second digital ancillary content on the basis of which of the second and third sets of format attributes yields a more satisfactory play out.

5. The method of claim 4 wherein which of the second and third sets of format attributes yields a more satisfactory play out is determined in accordance with at least one criterion established by an exhibitor.

6. The method according claim 1 wherein the step of selecting the first digital ancillary content comprises the step of:
identifying a digital ancillary content title having at least one attribute of its format attributes incompatible with the digital cinema feature;
processing the digital ancillary content title having at least one attribute of its format attributes incompatible to render that format attribute compatible.

7. The method according to claim 1 further comprising the steps of
(d) presenting the warning to an operator;
(e) accepting an override of the warning from the operator to select the ancillary content title notwithstanding the lack of compatibility.

8. The method of claim 7 wherein step (e) is performed in advance of step (d), whereby accepting the override constitutes an exhibitor policy.

9. The method according to claim 1 wherein compatibility of the ancillary content title with the digital cinema feature is determined by the steps of:
comparing each of the format attributes of the selected ancillary content title to each of the corresponding format attribute of the digital cinema feature to establish a quality assessment for each format attribute to which format attribute of the ancillary content title has lowest quality; and
determining if the lowest quality format attribute of the ancillary content title will inhibit play out according to exhibitor policy in order to establish compatibility of the selected ancillary content title.

10. The method according to claim 1 wherein the format attributes include, aspect ratio, frame rate, resolution, image stereoscopy, and peak bit rate.

11. A digital cinema exhibition system including media server configured to select a digital ancillary content title for presentation with a digital cinema feature by (a) determining format attributes associated with the digital cinema feature; (b) selecting a digital ancillary content title having a set of format attributes at least compatible with the format of the digital feature; otherwise, (c) if no digital ancillary content titles have set of format attributes at least compatible with the digital cinema feature, then generating a warning.

12. The apparatus according to claim 11 wherein the media server determines the format attributes of the digital cinema feature by examining first metadata associated with the digital cinema feature.

13. The apparatus according to claim 11 wherein the media server selects a digital ancillary content title by examining second metadata associated with the digital ancillary content title.

14. The apparatus according to claim 11 wherein the media server selects the digital ancillary content by identifying at least a first and second digital ancillary content titles which have compatible format attributes; and then selecting among the first and second digital ancillary content titles having compatible format attributes, the digital ancillary content title whose format attributes yield a more satisfactory play out.

15. The apparatus according to claim 1 wherein the media server selects the digital ancillary content title by identifying a digital ancillary content title having at least one attribute of its format attributes incompatible with the digital cinema feature; and then processing the digital ancillary content title having at least one attribute of its format attributes incompatible to render that format attribute compatible.

16. The apparatus according to claim 11 wherein the media server presents the warning to an operator and accepts an override of the warning from the operator to select the ancillary content title notwithstanding the lack of compatibility.

17. The apparatus according to claim 11 wherein the media server determines compatibility of the ancillary content title with the digital cinema feature by comparing each of the format attributes of the selected ancillary content title to each of the corresponding format attribute of the digital cinema feature to establish a quality assessment for each format attribute to which format attribute of the ancillary content title has lowest quality; and determining if the lowest quality format attribute of the ancillary content title will inhibit play out according to exhibitor policy in order to establish compatibility of the selected ancillary content title.

18. The apparatus according to claim 11 wherein the format attributes include, aspect ratio, frame rate, resolution, image stereoscopy, and peak bit rate
